(19) United States
(12) Patent Application Publication
(10) Pub. No.: US 2003/0083887 A1
(43) Pub. Date: May 1, 2003

(54) Multimedia recording entertainment industry

(76) Inventor: Da?apos;Quan James Allen Wilson III, Lawrence, KS (US)

Correspondence Address: DA"QUAN JAMES ALLEN WILSON III, 11911 NEWTON STREET #69, GRANDSVIEW, MO, 64030, US

(21) Appl. No.: 09/951,961

(22) Filed: Sep. 14, 2001

(51) Int. Cl. G06F 17/60

(52) U.S. Cl. 705/1

(57) ABSTRACT

A world wide virtual reality interactive web based game where participants carry on day to day business mimicking the INDUSTRY of the real world to each the goal is excellence and the opportunity to live out there wildest dreams of being a superstar, recording artist or a media personality. with monetary goals and the chance of a future in these field of choice MUSIC, TELEVISION, AND OR MULTIMEDIA ENTERTAINMENT.

### BACKGROUND OF THE INVENTION

1. Field of the Invention

The present invention is related to an apparatus for stabilizing the music, multimedia and entertainment fields; when corporate greed has deteriorated the trust given by the people. Even more so, the present invention is related to an apparatus for removing some of the damage done by the music, multimedia and entertainment field and their governing bodies.

2. The Industry, Particularly Multimedia Recording and Entertainment, is Composed of Several Parties

Each component of the industry is exploited by big corporations, which are bilking millions of dollars each year. To wit, each component, all though not adjacent, acts as a vehicle to fuel each other's components. The industry acts as a cushion or shock absorber for the people, limiting our choices in what we buy, see and/or hear, in such things as television, national publications, movies and advertisement. The industry runs its day to day business unaffected by how we as the people feel. The damages done to the democratic structure are several, the main being the people who are limited to what the industry deems as entertainment, multimedia, music, advertisement, etc. The result is millions of various artists, media personalities, thespians, models, comedians, and all other forms of talent go unnoticed or are simply discarded or set aside for reasons unknown, personal and/or professional. Therefore, a need exists for an alternate industry or a Minor League of the Industry, which does not unnecessarily vex the people or limit their range of choices. This alternate industry will simply be known as the Undustry.

### SUMMARY OF THE INVENTION

Accordingly, it is a primary object of the present invention to provide a new and viable Multimedia Recording and Entertainment Industry. This new industry, to be known henceforth as the Undustry, will allow the public a much more diverse and wider range of choices to choose from. The object of the present invention is as follows; to provide a competitive atmosphere and jobs in the fields of multimedia, the arts and entertainment and/or recording industry for the new millennium. It is another object of the present invention to provide artists with a development program if one wishes to have a career in mainstream media recording and entertainment industries. As well as an apprenticeship program for behind the scene careers in similar capacities. These and other objects of the present invention are achieved by The Undustry. here every facet of business is conducted in the likeness of mainstream industries. For example, marketing strategies, relentless campaigning, competing for airtime at various stations around the world, distributions, publishing, the management of material/archiving Undustry footage, documentaries, as well as a coalition. A watch dog group will protect the unsigned artist in the day to day dealing with mainstream or otherwise. Other objects and advantages of the present invention will become apparent from the following description taken in connection with the accompanying detail of description. It is set forth by the way of procedure. The eleven steps are the best mode currently known to the inventor for carrying out this invention, this means in any order, one through fifteen.

Starving Artist Coalition (S.A.C.).

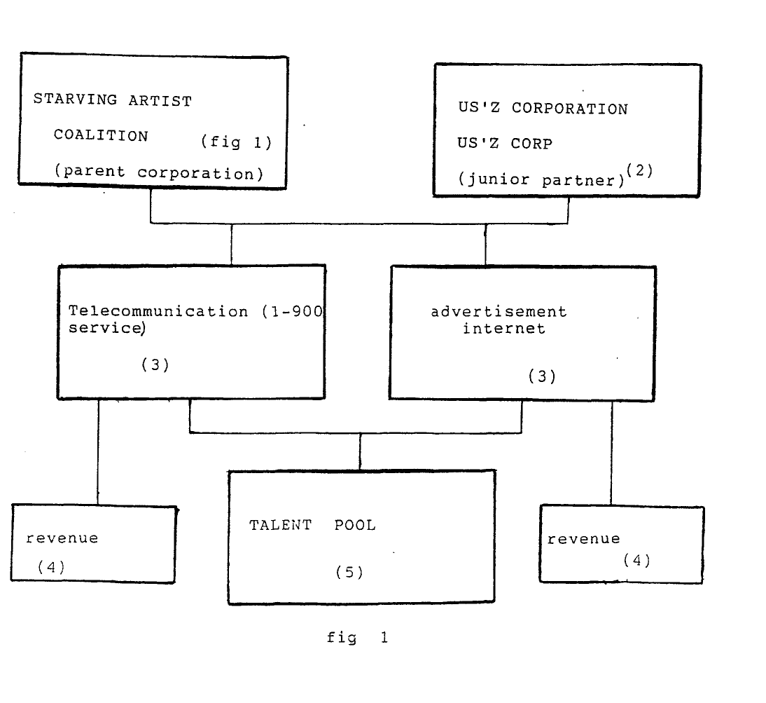

S.A.C. (FIG. 1) A Not-For-Profit Organization

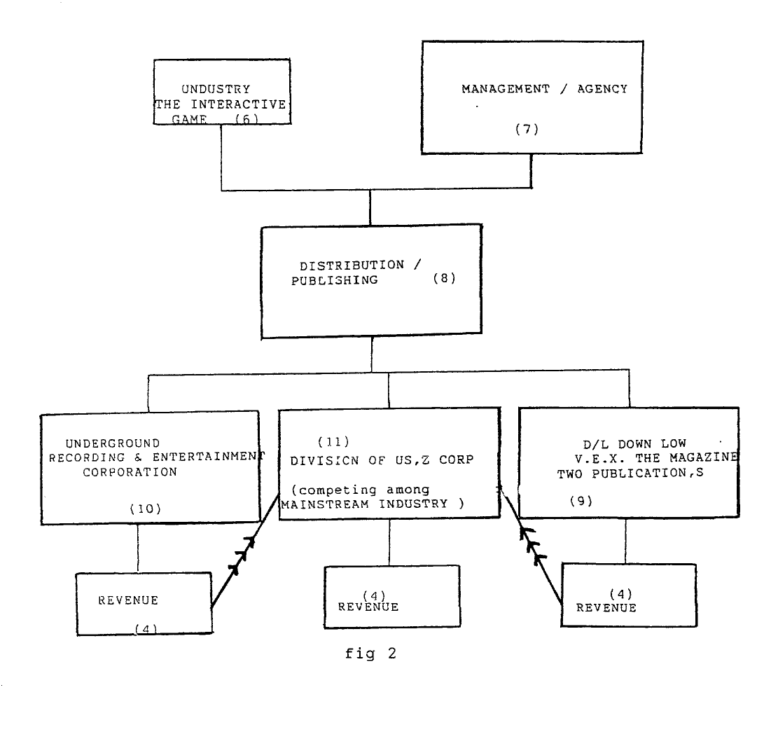

The duties of corporation are; to bring about change and fair practices on behalf of all unsigned artists. Its full scope will be the arts. Also, this not-for-profit organization will dual as a publishing company to protect the artistical right of the artists that wish to publish with the Undustry, to aid in the documentation and or give advice on all infringement of copy written material belonging to individuals or the Us'Z Corp. (FIG. 2) as a whole, not to withstand legal action. This will create a definite separation and assist in identifying what belongs to the mainstream industry and what belongs to Us'Z Corp. when considering royalties from air play and downloading via the Internet, or use in public domain. Lastly, to implement the universal Undustry point system and rules and regulations binding the artist and Us'Z Corp., Undustry. This governing body for this exciting new Undustry will allow members to access information or voice their opinions for or against infractions with the industry when dealings arise. S.A.C. (FIG. 1) will follow up with any and all charges and infraction and cite misuses of any member affiliated with the not-for-profit organization.

S.A.C. believes that all art should be recognized no matter how great or small. It is the parent organization because of its protective instinct and embodiment of the whole scope of the idea from start to end. S.A.C. (FIG. 1) is the founder of all ideas of Undaground Publication and part founder of (FIG. 8) publishing, as well as, (FIG. 5) and (FIG. 12). All will be explained in each figure description.

### BRIEF DESCRIPTION

### Steps Supported by Flow Chart, with Descriptions of Business Practice and Procedures

1. STARVING ARTIST COALITION (parent corporation)

2. Us'Z Corp. (junior partner)

3. Advertisement, 1-900 (telecommunications number)

4. Revenue (fuel for venture)

5. Talent pool

6. Undustry (the game)

7. Management agency

8. Distribution, publishing (the joint venture)

9. D.L., V.E.X (Undaground publications)

10. Us'Z (Undaground recording corporation)

11. A division of Us'Z Corp. (competing among mainstream Industry)

12. 24 hour access channel

13. Us'Z (television, motion picture studios)

14. Separation of the two corporations (joint ventures)

15. S.A.C. (assuming role)

15 claims 3 models

FIGS. 1-15 3 flow-charts

### Preamble

Male Voice: You must be 18 years or older or have parental permission to continue this phone call.

Female Voice: Then you for calling Us'Z, the newest multimedia corporation. The price of this call is $2.99 per minute. The average call is five minutes from this point. You have three seconds to hang up before the charges will begin.

Welcome to the exciting world of multimedia and entertainment. Our goal is to give all aspiring Musicians, Comedians, Models and up and coming artists' an opportunity to make a living in the field of their dreams. If you have talent, here is your chance to shine.

Have you ever been ignored or have not received any feedback on material submitted? Well, welcome to Us'Z the newest Multimedia Company where dreams come true. The price of this call is your lifetime registration fee in the Starving Artist Coalition, which protects unsigned artists. All we need is your individual or group name, a contact person, and an existing telephone number and address.

Your material can be cut or uncut, just make it your best work. Compared results will be posted in the national publication “Undaground (Underground) Magazine”. Everyone has a chance to be in the publication and other upcoming events.

Please stay on the line and hold for an operator.

US'z Corp:

Assumes the junior role from the onset, but quickly becomes a chief player in the scheme of things. Its duties in the beginning will be two fold to evaluate the talent referred by (S.A.C FIG. 1). As well as assist the (S.A.C. FIG. 1) in the registration of all game participants It is also the founder of (FIG. 6) Undustry the game, (FIG. 8) (FIGS. 10,11,13) all will be explained in detail description of each figure.

Advertisement/1-900 Service:

All though each component has been used to a certain extent. The uniqueness of combining the two generate capitol and a viable talent pool. It has never been used by any recording, multimedia, entertainment corporation or independent label, and or agency nationallly, or worldwide. And if so is not being actively used by any one, group or corporation to obtain the same goals. To create an interactive virtual reality game.

Revenue:

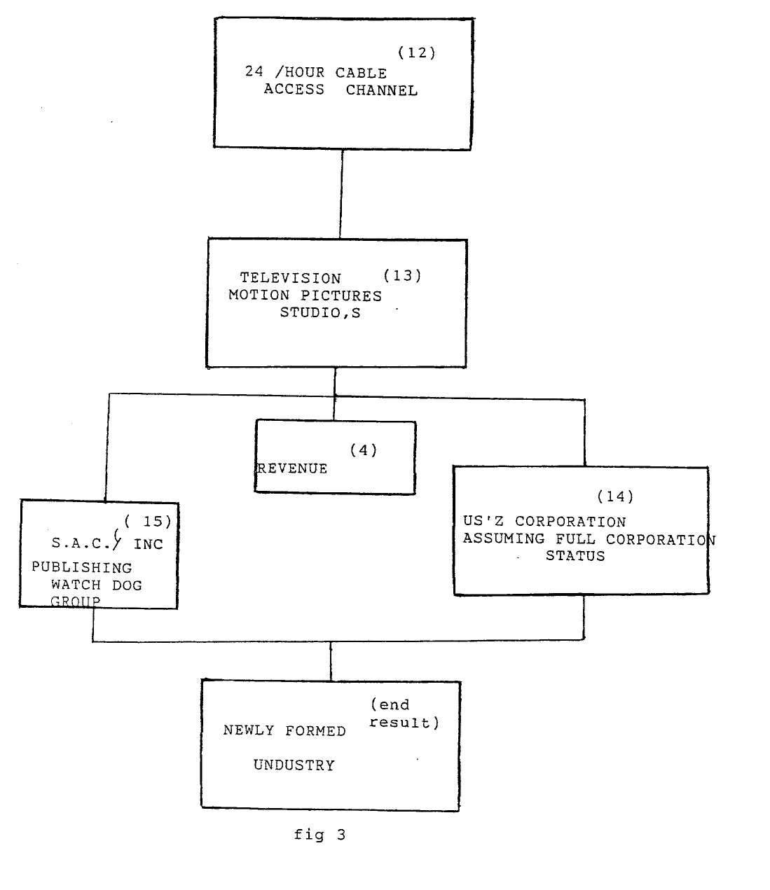

Are the efforts put forth by (S.A.C. FIG. 1) and (US'z CORP FIG. 2). The dedication to the business plan, aggressive marketing, campaigning via mainstream industries, telecommunication media as touched upon in (FIG. 3). Generating enough capitol to further venture as shown in flow chart (FIGS. 7,8,9). And the purchase of relevant equipment.

Talent Pool:

Consist of all correspondence of (FIG. 3, ADV/1-900 SERVICE). All become lifetime members of the (S.A.C., FIG. 1). To which registered member than fall under the scope of all discussed throughout the patent and are entered into the field of play (FIG. 6 UNDUSTRY GAME). Monetary gains and contract.

Undustry the Game:

Is played out in reality simultaneously by all participants. Movement and results will be posted via internet and publications.

Management Agency

S.A.C.(FIG. 1) and US'z corp (FIG. 2) believing all talent with practice and persistence can be elevated. So with this being said there will be an artist development program will be offered coupled by the apprenticeship program for the career minded individuals who wish go on to main-stream in front of or behind the scenes in the field of choice.

Publishing/Distribution

This joint venture by S.A.C.(FIG. 1) and (FIG. 2) US'z CORP. of publishing, and or distribution of said artist are based solely upon work we deem there is a market for. The venture of publishing/distribution of material by S.A.C, US'Z CORP (FIGS. 1,2) Is offered by the two entities to participant for there protection. Since the internet will be a source of information gathering downloading. which will result in royalties and the need to know who get them ASCAP/BMI/SAC/or other agencies used traditionally by independent or otherwise.

D.L/V.E.X

Two publication the essence of the streets. D.L. aka Down Low is a music magazine for the artist seldom seen or heard. Informative reading on who, what and where of the UNDERGROUND scene, music information comedic spotlight, and studio reviews, etc.

V.E.X

USED FOR SHOWCASING THE ROUND THE WAY MODELS MALE OR FEMALE THESIPIAN of the hood and workshop theatre informative information on all topic in society news, sports nationally.

Underground/Recording Industry.

As a result US'Z CORP (FIG. 2) participation naturally will become an outlet for underground talent to showcase talents which would otherwise go unnotice contracts, etc. And being that its the first company to make its intention know fully and beforehand make it the official HOME OF UNDERGROUND MUSIC.

US'Z Coorp

Mainstream Industry Division

Naturally the talent level of some participant will be that of mainstream icon, which will allow US'Z TO CREATE and or sign individuals, or groups from the talent pool (FIG. 5) and forge into mainstream channels

Total Access Channel

A future endeavor, also a joint effort of S.A.C. (FIG. 1) US'Z CORP (FIG. 2) to showcase underground talent, first run movies, comedic debuts, news programming for all age viewer S.A.C.(FIG. 1) will serve as the watchdog in the tastefulness in programming as well as the movement of this channel.

US'z

Television/Motion Picture Studios:

It is obvious that we will want to create some sort of separation from mainstream. We feel independence can be achieved by the building of our own facilities as well as a station etc, emitting a satellite signal around the world. Therefore creating no influence by mainstream in anyway.

S.A.C./US'Z Corp:

The Impending Separation

Both entities although separate. Throughout the length of the patent if granted will work towards mutual goals. Each entiti by the end of the fourth year should be totally independent of each other but with common goals to achieve still. This being the creation of an alter industry competing with the mainstream industry for the same consumer dollars by the final year of a twenty year patent if granted. Mainstream to extent in its own right.

US'Z CORP no longer a junior partner but a self maintained multimedia group fueling its ventures on its own and for, profit.

S.A.C.

Assuming the Role:

In the end S.A.C. (FIG. 1) role will be that of the watch dog group protecting the right,s of all unsigned artist, the symbol of fairness, lobbying for change where concern for the industry and underground as a whole, its acts and its member We hope to obtain full support from the big five music and entertainment corporation,s as well as there independent label,s. But it is not a criterion. Publishing, consultant to mainstream entertainment, to bring about change in how talent is evaluated and or used. lastly archive footage will be kept and constantly updated. A place for potential client can access archive,s for further evaluation and or consulting.

1 Our first claim is a fact that more talent possible better on is turned away or deter due to so few opportunities.

2 The two corporation are founded by the youth of tomorrow and therefore represent the culture of tomorrow. Not a mirror image mass media feel the culture of tomorrow should be.

3 It is in the true sense of the word a VER An INTERACTIVE VIRTUAL REALITY GAME believe to be the first of its kind.

4 the coalition (STARVING ARTIST COALITION) is also believe to be the first of its kind. Although similar organization exist none currently protect unsigned artist.

5 Unlike the real world of these types of INDUSTRY. THE STANDARDS OF EXCELLENCE will be judge on a curve giving all participant the opportunity to shine in there respective classes.

6 It is our belief that we are the first OFFICAL MINOR LEAGUE OF INDUSTRY.
